(19) United States
(12) Patent Application Publication
(10) Pub. No.: US 2017/0161620 A1
(43) Pub. Date: Jun. 8, 2017

(54) DETERMINING A MINIMAL EXPLANATION

(71) Applicant: International Business Machines Corporation, Armonk, NY (US)

(72) Inventors: Ulrich M. Junker, Biot (FR); Olivier M. Lhomme, Cagnes-sur-Mer (FR)

(21) Appl. No.: 14/962,758

(22) Filed: Dec. 8, 2015

(51) Int. Cl. G06N 5/04

(52) U.S. Cl. CPC G06N 5/04

(57) ABSTRACT

A method, computer program product and system for determining a minimal explanation. A model comprising a plurality of constraints is received. An output for the model is determined and a subset of the constraints that provide the same output for the model is constructed. The construction includes determining a first constraint that forms part of the subset of the constraints, testing the constraint(s) that form the subset of the constraints to determine if the subset of constraints provides the same output for the model, selecting a further constraint that has a variable in common with at least one constraint in the subset of constraints, and repeating the testing of the constraint(s) and the selecting of the further constraint until the testing of the constraint(s) that form the subset of the constraints determines that the subset of the constraints does provide the same output for the model.

### TECHNICAL FIELD

The present invention relates to the field of models built using a set of constraints, and more particularly, to finding a minimal explanation for an output of a model comprising a plurality of constraints.

### BACKGROUND

Models built using a set of constraints are used in many technical areas. Real world systems can be modelled using a set of suitable constraints and a solver can provide a solution to the model or prove the absence of solution. An explanation for the output provided by the solver is required in some cases. An explanation may be sought for the solution itself, for a specific property of this solution, or for the absence of solution, all of which can be considered as an output from the model.

Computing systems using a solver are able to make logical inferences from the model and such solvers are used in many different domains in computer science. Sometimes the inferences that are generated by such a solver may surprise people. A surprising inference may reveal a bug in the solver, or that a wrong model has been given to the solver, for example. A surprising inference may require significant cognitive effort to be understood. As a result, an approach is needed to reduce the cognitive effort required to understand the inference.

### BRIEF SUMMARY

In one embodiment of the present invention, a computer implemented method for determining a minimal explanation comprises receiving a model comprising a plurality of constraints. The method further comprises determining an output for the model. The method additionally comprises constructing, by a processor, a subset of the constraints that provide the same output for the model. The construction comprises determining a first constraint that forms part of the subset of the constraints. The construction further comprises testing the constraint(s) that form the subset of the constraints to determine if the subset of constraints provides the same output for the model. Furthermore, the construction comprises selecting a further constraint that has a variable in common with at least one constraint in the subset of constraints, the further constraint forming part of the subset of constraints. Additionally, the construction comprises repeating the testing of the constraint(s) and the selecting of the further constraint until the testing of the constraint(s) that form the subset of the constraints determines that the subset of constraints does provide the same output for the model.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 is a schematic diagram of a model in accordance with an embodiment of the present invention;

FIG. 2 is a further schematic diagram of the model in accordance with an embodiment of the present invention;

FIG. 3 is a schematic diagram of a computing system in accordance with an embodiment of the present invention;

FIG. 4 is a graph of a set of connected constraints of the model in accordance with an embodiment of the present invention;

FIG. 5 is a flowchart of a method of finding a minimal explanation in accordance with an embodiment of the present invention; and

FIG. 6 is a flowchart of a method of selecting and processing a candidate constraint for the minimal explanation in accordance with an embodiment of the present invention.

### DETAILED DESCRIPTION

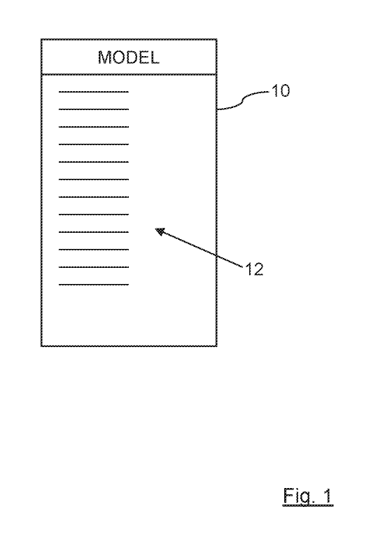

FIG. 1 illustrates a model 10 that is comprised of a plurality of constraints 12. Computing systems using a solver are able to make logical inferences from the model 10 and such solvers are used in many different domains in computer science. Sometimes the inferences that are generated by such a solver may surprise people. A surprising inference may reveal a bug in the solver, or that a wrong model has been given to the solver, for example. A surprising inference may require significant cognitive effort to be understood. The concept of a minimal explanation is a powerful approach to reduce the cognitive effort required to understand an inference, and can be used directly in algorithms in order to automatically improve their behavior.

A minimal explanation can be considered to be a subset of the constraints 12 that describe the result given by the model 10 under the operation of the solver. For example, the model 10 may be modelling the launch of a new product, with constraints 12 relating to resources required for marketing and legal approval and so on. The model 10 is sent to the solver, which provides an output. A minimal explanation would be those constraints 12 that result in the same output. For example, a solver may produce an output from a model 10 that a new product cannot be launched within 3 months, but this output cannot easily be understood without knowing which constraints 12 in particular lead to the output. A minimal explanation will be those constraints 12 that produce the same output using the same solver.

The time needed to compute a minimal explanation may be large, depending on the kind of output under consideration. In particular, for combinatorial optimization problems, such as scheduling problems, where a cognitively challenging output can be, for example, that there is no solution to a given problem, it can take a long time to find a minimal explanation to this absence of solution. Therefore, a system is provided that improves the performance of finding a minimal explanation.

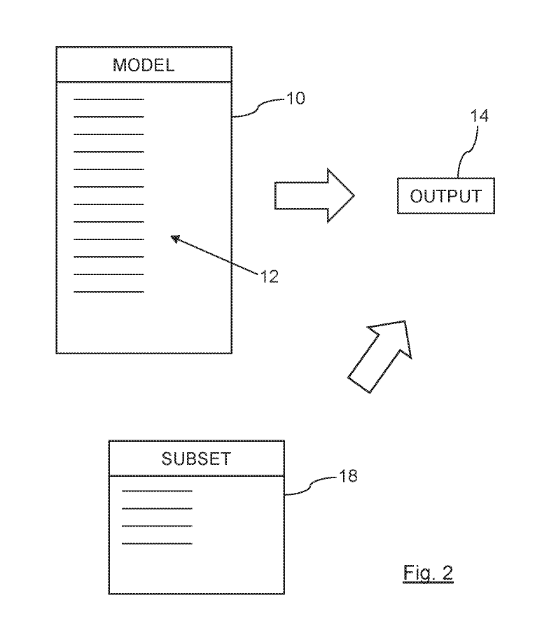

FIG. 2 further illustrates conceptually the model 10, which is comprised of the plurality of constraints 12. An output 14 for the model 10 is produced for the constraints 12 of the model 10 under the action of a solver. For example, an output 14 for a model 10 could be x=1, y=2, z=3. This may raise the question as to why the value of x is not equal to 3, for example. A subset 18 of the constraints can be considered a minimal explanation of the output 14, if the subset 18 provides the same output 14. The subset 18 lists those constraints 12 that are the drivers of the output 14, and hence form a minimal explanation (a smaller number of constraints 12 than the entire set of constraints 12 in the model 10 that nevertheless still provide the same output 14 for the model 10). It is noted that there could be several different minimal explanations 18 using different numbers of constraints 12 in the subset 18.

For example, the model 10 could relate to the building of five houses. For each house, several tasks must be planned, such as masonry, carpentry, plumbing, ceiling, roofing, painting, windows, façade, garden, etc. Some of constraints 12 relate to precedence (masonry before roofing, plumbing before painting etc.) and some relate to resources (a single plumber works on all houses, the roof in houses 2 and 3 are made by the same workers, etc.). A constraint solver infers (from the model 10) that the garden of the first house cannot be finished before Christmas. An explanation for this inference is required, which is equal to a minimal subset of the constraints 12 that leads the inference.

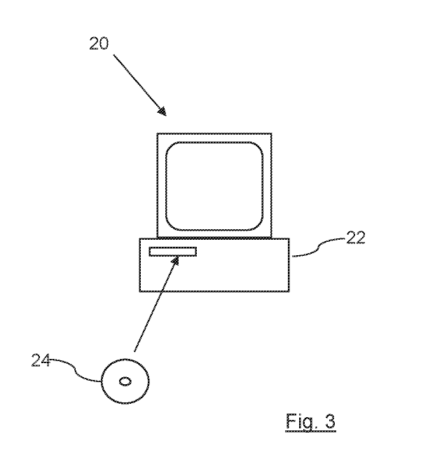

FIG. 3 illustrates a computer system 20 that can be used to operate on the model 10. The computer system 20 comprises a processor 22 that can be controlled to perform operations with respect to the model 10 and can operate a solver to provide the output 14 from the model 10. A computer program product on a computer readable medium 24 can be used to control the processor 22. The computer readable medium 24 is a CD-ROM 24 and the computer program product stored thereon comprises a set of instructions for controlling the processor 22. The processor 22 executes one or more algorithms with respect to the model 10, in order to work out a minimal explanation 18 for the model 10, given the output 14 produced by the model 10 from the constraints 12.

The methodology performed by the processor 22 for generating the minimal explanation 18 starts from a current partial explanation, called partialExp. By definition, this explanation is a subset of a minimal explanation 18. The current partial explanation is initialized with a non-empty set, which is called a seed. The seed is a part of a minimal explanation 18. In some cases, for some specific reasons, such an initial seed is known. For example, given a constraint model M where it is desirable to know why a variable X has been assigned a value v, the computer system 20 will find a minimal explanation of the fact that the model M′ derived from M has no solution: in this case, the derived model M′ is defined to be the union of M and the constraint{X!=v}, meaning that X is different from v, and it is known in advance that the constraint X!=v is necessarily in the minimal explanation, and then this constraint 12 can be taken as the seed without computation.

In other cases, the computer system 20 does not know a seed without performing some computation. In such cases, the processor 22 will simply compute a seed. In order to carry this out, the processor 22 will use one of the known methods to compute the first element of an explanation. The best approaches use a binary search, and calls O(log n) times the solver, where n is the number of candidates that could appear in the minimal explanation. Then, a seed can be found in O(log n) calls to the solver. For computing more efficiently a minimal explanation, the processor 22 can first order the different constraints 12 by their number of neighbors, where a neighbor is defined as any other constraint 12 that has a variable in common with the constraint 12 in question. The binary search is then implemented in such a way that the processor 22 finds the constraint 12 that is the least connected amongst the constraints 12 of the minimal explanation 18.

The advantage of beginning with the least connected element of a minimal explanation will become clear from the description below. The processor 22 will consider as candidates to be injected in the current partial explanation only those that are connected to the constraints 12 of the current partial explanation. The fewer constraints 12 that have to be considered the better, since this reduces the time required to identify a minimal explanation 18. Hence, beginning with the least connected constraint 12 of a minimal explanation 18 is a heuristic that may lead to the consideration of fewer possible candidates.

The processor 22 provides an extension of the current partial explanation. The processor 22 is operated to address the problem of how to extend the current partial explanation, while preserving the property of the partial explanation being a subset of a minimal explanation 18. The approach used is built on the idea that it is sufficient to extend the current partial explanation by considering only the neighbors of the constraints 12 in the current partial explanation. The rationale behind this idea is that a minimal explanation 18 is necessarily composed of constraints 12 that are connected; otherwise, the explanation 18 will not be minimal.

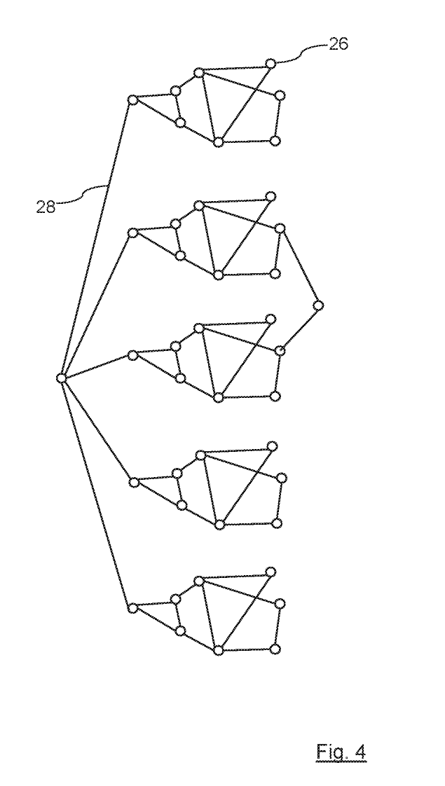

In other words, there are different ways of constructing the minimal explanation 18. The processor 22 has a degree of freedom in choosing the next constraint 12 that is added to the current partial explanation. The processor 22 exploits the fact that the processor 22 can complete the current partial explanation by following the connections. In a sparse graph, the number of candidates to consider is strongly reduced. FIG. 4 shows a graph comprised of nodes 26 and edges 28. In this graph, the nodes 26 represent constraints 12 within the model 10 and the edges 28 represent connections between constraints 12 that are considered to be neighbors in that the two connected constraints 12 have at least one variable in common.

The implementation executed by the processor 22 performs a focused binary search. Instead of considering the n possible candidates, the processor 22 considers only those constraints 12 that are connected to constraints 12 within the current partial explanation. This is achieved with reference to the graph of FIG. 4. Let k be the number of constraints 12 that are connected to at least one constraint 12 of the current partial explanation, and not already present in the current partial explanation. Then, the extension step requires O(log k) calls to the solver instead of O(log n) calls. This is especially useful when the current partial explanation is weakly connected to the remaining part of the model. In some cases, the processor 22 end up with k=2 or even k=1, whereas n can be very large, leading to a big improvement in time for computing a minimal explanation, when compared to existing techniques.

When selecting a new constraint 12 for consideration, the processor 22 navigates the built graph from a node defining a constraint 12 in the subset 18 of constraints to a connected node defining a constraint 12 not in the subset 18 of constraints. A heuristic to reach a better efficiency is to order the k neighbors by their number of neighbors outside the current explanation (and inside the still possible candidates), and the binary search is implemented so that the processor 22 returns the least connected constraint 12 that extends the current explanation. The connected node selected has the lowest number of connections of all of the nodes connected to the node defining a constraint 12 in the subset 18 of constraints.

Referring to the example mentioned in the text above, this is an example in the context of scheduling problems. There is a need to build five houses. Each house requires tasks, such as masonry, carpentry, plumbing, ceiling, roofing, painting, windows, façade and the garden to be completed. Precedence constraints 12 between the tasks of a particular house are given, for instance, such that masonry precedes roofing, plumbing precedes painting, and also there are constraints 12 that relate to some resources that are shared between some houses: the same plumber works on the five houses, the roof in the houses 2 and 3 are made by the same workers, and so on.

The graph shown in FIG. 4 is a simplified version of the constraints 12 that make up the “five house” problem defined by the model 10. It can be seen that the graph is relatively sparse, in the sense that most of the nodes 26 connect to only a small number of other nodes 26 and also that most of the nodes 26 are clustered into similar groups of five, representing the five houses being constructed. Nodes 26 are connected together in the graph if the two connected nodes 26 represent two constraints 12 that share a variable in common. The solver run by the processor 22 infers that the garden of the first house cannot be finished before Christmas; this is the output of the model 10. The processor 22 is thus looking for an explanation of why a new model M′ has no solution, where M′ is the initial model 10 with the additional constraint 12 that the garden of the first house must be finished before Christmas. Assuming that the minimal explanation is the following set of constraints:

{the garden of the first house must be finished before Christmas,
the garden of the first house must begin after the roofing of the first house,
the roofing of the first house must begin after the masonry of the first house}.

The method performed by the processor starts from the seed “the garden of the first house must be finished before Christmas.” Then the processor 22 tries to extend the seed by looking at the neighbors of the seed of which there is only one: “the garden of the first house must begin after the roofing of the first house.” A call to the solver is performed to check if this is a sufficient explanation, which is not the case. Therefore one new neighbor is entered: “the roofing of the first house must begin after the masonry of the first house.” A call to the solver is performed again and this time returns an output that the set of these three constraints 12 is a sufficient explanation. The processor 22 has got to the minimal explanation 18 with only two calls to the solver.

The methodology used by the processor 22 leverages the property that an explanation verifies a connection property because the explanation is minimal. The processor 22 exploits this property and accelerates the computation of an explanation for sparse graphs. The methodology starts from a partial explanation (which has to be seeded in some way) and tries to extend the partial explanation by testing the neighbor constraints 12 of a constraint 12 that is already present in the partial explanation. Once the partial explanation provides the same outcome as the entire model 10, then the partial explanation is the minimal explanation 18 of the outcome. At this point, the processor 12 has completed the necessary steps to determine the minimal explanation and the process can terminate.

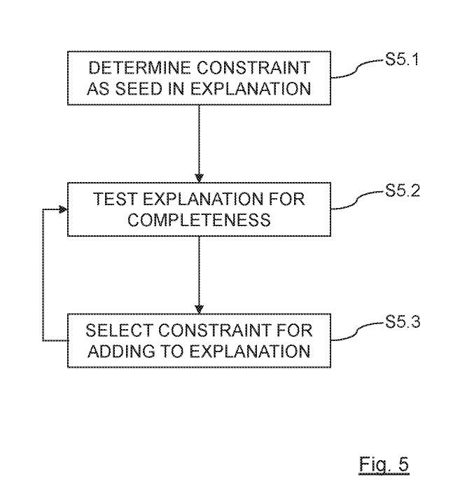

FIG. 5 summarizes the method executed by the processor 22. The processor 22 receives the model 10, which is comprised of the plurality of constraints 12 and determines an output 14 for the model 10, and then constructs a subset 18 of the constraints 12 that provides the same output 14 for the model 10. FIG. 5 shows the steps required in the construction of the subset 18, which defines a minimal explanation of the output 14. This subset 18 of constraints 12 provides the same output 14 as the whole model 10 and hence provides a more understandable explanation of the output 14, given the model 10 and the constraints 12.

Step S5.1 comprises determining a first constraint 12 that forms part of the subset 18 of the constraints 12. As discussed above, this can be done in a number of different ways, depending upon the preferred methodology, but at this point the processor 22 finds a first constraint 12 for the minimal explanation defined by the subset 18 of constraints 12.

At step S5.2, the method continues by testing the constraint(s) 12 that form the subset 18 of the constraints 12, in order to determine if the subset 18 of constraints 12 provides the same output 14 for the model 10 (and the process is therefore ended). At this point, the processor 22 is checking the completeness of the current explanation 18. In the first pass through the method shown in FIG. 5, the subset 18 has only a single constraint 18 and the subset 18 with the single starting constraint 12 could be the minimal explanation sought, although this is unlikely. The test in step S5.2 involves the processor 22 invoking the solver to ascertain if the subset 18 provides the same output 14 for the model 10. If not, then one or more further constraints 12 are sought to be added to the subset 18.

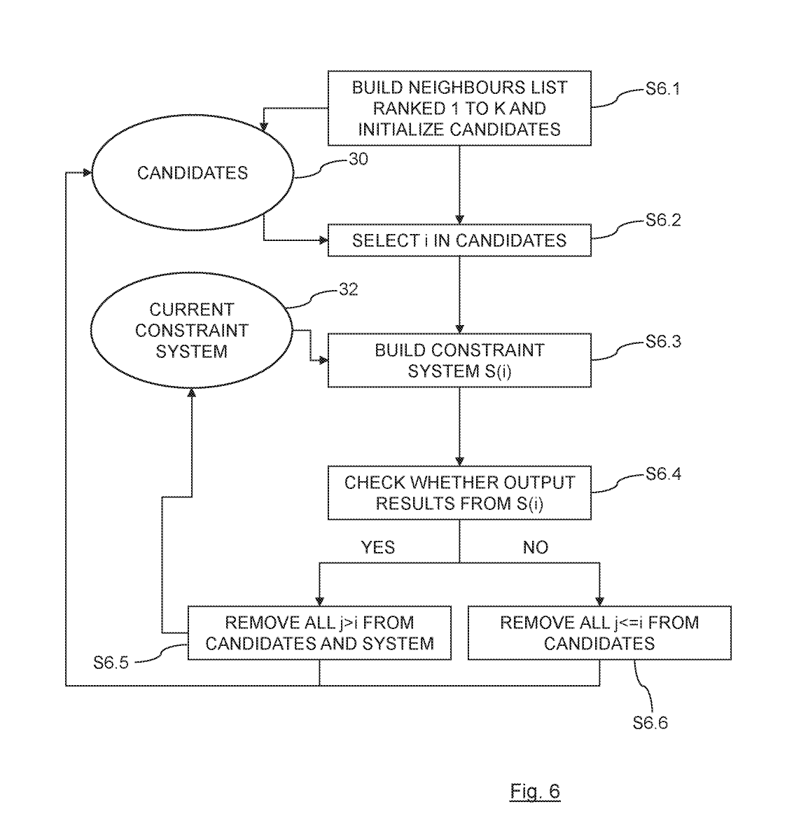

The final step in the method is Step S5.3, which comprises selecting a further constraint 12 that has a variable in common with at least one constraint 12 in the subset 18 of constraints 12, where the further constraint 12 forms part of the subset 18 of constraints 12. The further constraint 18 is chosen as one that is connected to at least one of the constraints 12 already present within the subset 18. As can be seen from FIG. 4, the constraints 12 within the model 10 can be represented as a connected graph and this allows the identification of a candidate constraint 12 to be performed via a connection within the graph. This step S5.3 is described in more detail below, with reference to FIG. 6.

The algorithm operated by the processor 22 repeats the testing of the constraints 12 and the selecting of a further constraint 12 until the testing of the constraint(s) 12 that form the subset 18 of the constraints 12 (in step S5.2) determines that the subset 18 of constraints 12 does indeed provide the same output 14 from the model 10. In this way, a new constraint 12 is continually sought and then added to the subset 18 until the subset 18 does provide the same output 14, thereby confirming that the current members of the subset 18 do provide the sought minimal explanation.

FIG. 6 shows more detail of a preferred embodiment of the selecting of a further constraint 12 for adding to the minimal explanation 18. In FIG. 5, step 5.3 selects one constraint 12 to extend the current explanation. By construction, the processor 22 knows that one such constraint 12 must exist in the neighborhood of the current partial explanation (i.e., be connected to a constraint 12 that is already present in the partial explanation). The neighborhood of the current partial explanation is defined as all the constraints that are in currentSystem (which is comprised of all of the constraints 12 apart from any already eliminated, as explained below) and that are connected to at least one of the constraints 12 of the current partial explanation.

First, at step S6.1, the method builds a NeighborList, which is the list of all the constraints 12 of the neighborhood of a constraint 12 in the partial explanation, ranked from 1 to K, and initializes a set of candidate indices, which is called the candidates (numbered 30 in the Figure), from [1 . . . K]. Then, at step S6.2, the method selects any index in the candidates 30. The selection strategy may be to always take the largest index in the candidates 30, leading to a linear search, or it may be to take the median in the candidates 30, leading to a binary search. At this point, if there is only one remaining candidate constraint (all others having been eliminated), the last remaining constraint is necessarily the one which extends the current explanation and this step terminates the method, returning the sole remaining constraint 12 as the output of the method. Otherwise, at step S6.3, a current constraint system 32 is build, called S(i), which is defined as the union of partialExp and currentSystem, except the constraints occurring at ranks i+1 to K in the list NeighborList are excluded.

Then, at step S6.4, this current constraint system S(i) is sent to the constraint solver to check whether the solver can deduce from S(i) the output 14. If the answer is yes, then this means that the method proceeds to step S6.5 where the set of candidates is reduced by removing the candidates with indices i+1 to K and all the constraints occurring at ranks i+1 to K in the list NeighborList are definitely not in the explanation, and can therefore be removed from currentSystem 32 to simplify the constraint system. If the answer is no, then the solver cannot deduce from S(i) the output 14 and moves to step S6.6. Here, the process needs to take into account that at least one of the constraints that is not in S(i), and thus removes all candidates with a rank less than or equal to i.

To summarize the process shown in the FIG. 6, the processor 22 finds the constraint 12 with the smallest index i such that a call to the solver with the constraint system S(i) leads to the output 14, then adds the i-th constraint to the partial explanation 18, and removes from the currentSystem 32 all the constraints 12 with a rank greater than i in the list NeighborList such that:

partialExp:=partialExp+(constraint of rank i in NeighborList)

currentSystem:=currentSystem−(all constraints from rank i to K in NeighborList)

If this process is implemented in order to perform a binary search on NeighborList, and if K is the size of NeighborList, the method calls O(log K) times the constraint solver. A heuristic to reach a better efficiency is to order the K neighbors by their number of neighbors outside the current explanation (and inside currentSystem) and the binary search is implemented so that it returns the less connected element that extends the current explanation. Once the current explanation has been extended with one additional constraint 12, the method returns to the step S5.2 in FIG. 5.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method for determining a minimal explanation, the method comprising:
receiving a model comprising a plurality of constraints;
determining an output for the model; and
constructing, by a processor, a subset of the constraints that provide the same output for the model, the construction comprising:
determining a first constraint that forms part of the subset of the constraints;
testing the constraint(s) that form the subset of the constraints to determine if the subset of constraints provides the same output for the model;
selecting a further constraint that has a variable in common with at least one constraint in the subset of constraints, the further constraint forming part of the subset of constraints; and
repeating the testing of the constraint(s) and the selecting of the further constraint until the testing of the constraint(s) that form the subset of the constraints determines that the subset of constraints does provide the same output for the model.

2. The method as recited in claim 1, wherein the selecting of the further constraint that has the variable in common with at least one constraint in the subset of constraints, the further constraint forming part of the subset of constraints, comprises generating a list of candidate constraints from 1 to K each of which has a variable in common with at least one constraint in the subset of constraints and performing repeated binary searches on the list of candidate constraints until only one constraint remains.

3. The method as recited in claim 2, wherein the selecting of the further constraint that has the variable in common with at least one constraint in the subset of constraints, the further constraint forming part of the subset of constraints, comprises selecting a candidate i from the list of candidate constraints, building a current constraint system from the constraints of the model excluding the constraints i+1 to K from the candidate list, testing the current constraint system to determine if the current constraint system provides the same output for the model and removing all candidate constraints from i+1 to K from the candidates list and the current constraint system if the current constraint system does provide the same output for the model, or removing all candidate constraints from 1 to i from the candidates list if the current constraint system does not provide the same output for the model.

4. The method as recited in claim 1 further comprising:
building a graph of connected constraints wherein two constraints are connected if they share at least one variable, and wherein the selecting of the further constraint that has the variable in common with at least one constraint in the subset of constraints, the further constraint forming part of the subset of constraints comprises navigating the built graph from a node defining a constraint in the subset of constraints to a connected node defining a constraint not in the subset of constraints.

5. The method as recited in claim 4, wherein the connected node selected has a lowest number of connections of all of the nodes connected to the node defining the constraint in the subset of constraints.

6. A computer program product for determining a minimal explanation, the computer program product comprising a computer readable storage medium having program code embodied therewith, the program code comprising the programming instructions for:
receiving a model comprising a plurality of constraints;
determining an output for the model; and
constructing a subset of the constraints that provide the same output for the model, the construction comprising the programming instructions for:
determining a first constraint that forms part of the subset of the constraints;
testing the constraint(s) that form the subset of the constraints to determine if the subset of constraints provides the same output for the model;
selecting a further constraint that has a variable in common with at least one constraint in the subset of constraints, the further constraint forming part of the subset of constraints; and
repeating the testing of the constraint(s) and the selecting of the further constraint until the testing of the constraint(s) that form the subset of the constraints determines that the subset of constraints does provide the same output for the model.

7. The computer program product as recited in claim 6, wherein the programming instructions for selecting of the further constraint that has the variable in common with at least one constraint in the subset of constraints, the further constraint forming part of the subset of constraints, comprises the programming instructions for generating a list of candidate constraints from 1 to K each of which has a variable in common with at least one constraint in the subset of constraints and performing repeated binary searches on the list of candidate constraints until only one constraint remains.

8. The computer program product as recited in claim 7, wherein the programming instructions for selecting of the further constraint that has the variable in common with at least one constraint in the subset of constraints, the further constraint forming part of the subset of constraints, comprises the programming instructions for selecting a candidate i from the list of candidate constraints, building a current constraint system from the constraints of the model excluding the constraints i+1 to K from the candidate list, testing the current constraint system to determine if the current constraint system provides the same output for the model and removing all candidate constraints from i+1 to K from the candidates list and the current constraint system if the current constraint system does provide the same output for the model, or removing all candidate constraints from 1 to i from the candidates list if the current constraint system does not provide the same output for the model.

9. The computer program product as recited in claim 6, wherein the program code further comprises the programming instructions for:
building a graph of connected constraints wherein two constraints are connected if they share at least one variable, and wherein the programming instructions for selecting of the further constraint that has the variable in common with at least one constraint in the subset of constraints, the further constraint forming part of the subset of constraints comprises the programming instructions for navigating the built graph from a node defining a constraint in the subset of constraints to a connected node defining a constraint not in the subset of constraints.

10. The computer program product as recited in claim 9, wherein the connected node selected has a lowest number of connections of all of the nodes connected to the node defining the constraint in the subset of constraints.

11. A system, comprising:
a memory unit for storing a computer program for determining a minimal explanation; and
a processor coupled to the memory unit, wherein the processor is configured to execute the program instructions of the computer program comprising:
receiving a model comprising a plurality of constraints;
determining an output for the model; and
constructing a subset of the constraints that provide the same output for the model, the construction comprising the program instructions for:
determining a first constraint that forms part of the subset of the constraints;
testing the constraint(s) that form the subset of the constraints to determine if the subset of constraints provides the same output for the model;
selecting a further constraint that has a variable in common with at least one constraint in the subset of constraints, the further constraint forming part of the subset of constraints; and
repeating the testing of the constraint(s) and the selecting of the further constraint until the testing of the constraint(s) that form the subset of the constraints determines that the subset of constraints does provide the same output for the model.

12. The system as recited in claim 11, wherein the program instructions for selecting of the further constraint that has the variable in common with at least one constraint in the subset of constraints, the further constraint forming part of the subset of constraints, comprises the program instructions for generating a list of candidate constraints from 1 to K each of which has a variable in common with at least one constraint in the subset of constraints and performing repeated binary searches on the list of candidate constraints until only one constraint remains.

13. The system as recited in claim 12, wherein the program instructions for selecting of the further constraint that has the variable in common with at least one constraint in the subset of constraints, the further constraint forming part of the subset of constraints, comprises the program instructions for selecting a candidate i from the list of candidate constraints, building a current constraint system from the constraints of the model excluding the constraints i+1 to K from the candidate list, testing the current constraint system to determine if the current constraint system provides the same output for the model and removing all candidate constraints from i+1 to K from the candidates list and the current constraint system if the current constraint system does provide the same output for the model, or removing all candidate constraints from 1 to i from the candidates list if the current constraint system does not provide the same output for the model.

14. The system as recited in claim 11, wherein the program instructions of the computer program further comprise:
building a graph of connected constraints wherein two constraints are connected if they share at least one variable, and wherein the program instructions for selecting of the further constraint that has the variable in common with at least one constraint in the subset of constraints, the further constraint forming part of the subset of constraints comprises the program instructions for navigating the built graph from a node defining a constraint in the subset of constraints to a connected node defining a constraint not in the subset of constraints.

15. The system as recited in claim 14, wherein the connected node selected has a lowest number of connections of all of the nodes connected to the node defining the constraint in the subset of constraints.
